(19) United States
(12) Patent Application Publication
(10) Pub. No.: US 2012/0204117 A1
(43) Pub. Date: Aug. 9, 2012

(54) METHOD AND APPARATUS FOR A MULTI-USER SMART DISPLAY FOR DISPLAYING MULTIPLE SIMULTANEOUS SESSIONS

(75) Inventors: Abhishek Patil, San Diego, CA (US); Nobukazu Sugiyama, San Diego, CA (US); James Amendolagine, San Marcos, CA (US); Djung Nguyen, San Diego, CA (US)

(73) Assignee: SONY CORPORATION, Tokyo (JP)

(21) Appl. No.: 13/105,766

(22) Filed: May 11, 2011

Related U.S. Application Data
(60) Provisional application No. 61/439,317, filed on Feb. 3, 2011.

(51) Int. Cl. G06F 3/01

(52) U.S. Cl. 715/753

(57) ABSTRACT

A method and apparatus are provided for establishing a multi-user session having a plurality of users according to a general profile, the general profile comprising at least a desktop appearance specific to the multi-user session, receiving a session request from a first user of the plurality of users, retrieving a user profile for the first user, detecting a window position for the session request and generating a first user session for the first user at the window position based on the user profile, the user profile comprising at least a desktop appearance specific to the first user wherein the first user session runs simultaneously with the multi-user session and simultaneously displaying the multi-user session and the first user session, the first user session being displayed at a location corresponding to the detected window position.

This application claims the benefit of U.S. Provisional Application No. 61/439,317, entitled “Ability to Share Screen for Multi-User Session on Sony Interactive Table”, filed Feb. 3, 2011, which is incorporated in its entirety herein by reference.

### BACKGROUND OF THE INVENTION

Computers have become an integral tool for collaboration. With the growing importance of computers as tools for collaboration, multi-user tabletops have been introduced to allow for a number of individuals collaborating to view the subject of the collaboration at the same time. Larger screens have been introduced to offer the capability of allowing multiple people to interact to facilitate face-to-face collaboration, brainstorming, and decision-making.

### SUMMARY OF THE INVENTION

Several embodiments of the invention provide a processor configured to perform the steps comprising establishing a multi-user session having a plurality of users according to a general profile, the general profile comprising at least a desktop appearance specific to the multi-user session, receiving a session request from a first user of the plurality of users, retrieving a user profile for the first user, detecting a window position for the session request and generating a first user session for the first user at the window position based on the user profile, the user profile comprising at least a desktop appearance specific to the first user wherein the first user session runs simultaneously with the multi-user session and a display for simultaneously displaying the multi-user session including a desktop corresponding to the desktop appearance specific to the multi-user session and the first user session including a desktop corresponding to the desktop appearance specific to the first user, the first user session being displayed at a location corresponding to the detected window position.

In one embodiment, the invention can be characterized as a method comprising establishing a multi-user session having a plurality of users according to a general profile, the general profile comprising at least a desktop appearance specific to the multi-user session, receiving a session request from a first user of the plurality of users, retrieving a user profile for the first user, detecting a window position for the session request, generating a first user session for the first user at the window position based on the user profile, the user profile comprising at least a desktop appearance specific to the first user wherein the first user session runs simultaneously with the multi-user session and simultaneously displaying the multi-user session including a desktop corresponding to the desktop appearance specific to the multi-user session and the first user session including a desktop corresponding to the desktop appearance specific to the first user, the first user session being displayed at a location corresponding to the detected window position.

In another embodiment, the invention can be characterized as a tangible non-transitory computer readable medium storing one or more computer readable programs adapted to cause a processor based system to execute steps comprising establishing a multi-user session having a plurality of users according to a general profile, the general profile comprising at least a desktop appearance specific to the multi-user session, receiving a session request from a first user of the plurality of users, retrieving a user profile for the first user, detecting a window position for the session request, generating a first user session for the first user at the window position based on the user profile, the user profile comprising at least a desktop appearance specific to the first user wherein the first user session runs simultaneously with the multi-user session and simultaneously displaying the multi-user session including a desktop corresponding to the desktop appearance specific to the multi-user session and the first user session including a desktop corresponding to the desktop appearance specific to the first user, the first user session being displayed at a location corresponding to the detected window position.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a flow diagram of a method for establishing a multi-user session at the smart table according to several embodiments of the present invention.

FIG. 2 is a more detailed flow diagram of a process for establishing a user session at the smart table, according to several embodiments of the present invention.

FIG. 3 illustrates exemplary screen shots of the table while the process of creating a user specific session is being performed, according to several embodiments of the present invention.

FIG. 4 is a flow diagram of a process for receiving and executing commands received at the smart table, according to several embodiments of the present invention.

FIG. 5 is a flow diagram of a method for coupling an input device to the smart table, according to several embodiments of the present invention.

FIG. 6 is a block diagram illustrating a processor-based system that may be used to run, implement and/or execute the methods and/or techniques shown and described herein in accordance with embodiments of the present invention.

FIG. 7 is a flow diagram of a process for sharing an item displayed at the user-specific session with one or more users at other sessions being displayed on the smart table, according to several embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Typically multi-user tabletops allow for a number of individuals collaborating to view the subject of the collaboration at the same time and offer the capability of allowing multiple people to interact facilitating face-to-face collaboration, brainstorming, and decision-making. However, while these tabletops allow for a single large session accessible by all users of the session, if the user wishes to access information privately and/or access information within his/her own profile or with his/her own preferences, then the user will have to access such information at a separate computer and on a separate monitor, where the user can establish a new private session.

According to several embodiments, the present invention provides a smart table having a large screen allowing users to play games or browse the web via a large flat screen table interface (i.e., horizontal orientation). While the embodiments of the present invention are described below with respect to a flat screen table interface, it should be understood by one of ordinary skill in the art that the methods and techniques described herein may be implemented on any display regardless of the shape and or orientation of the display. For example, the methods and techniques below may be implemented on a board type display (i.e. vertical orientation), on a semi spherical display, a spherical display, and/or other display devices.

In one or more embodiments, the present invention enables different users to share the screen of the smart table interface and interact with others through a multi-user session providing access to all users, while simultaneously providing the user with a private user specific session by maintaining their own profile and login via their unique “login” pattern. Thus the invention provides for screen sharing between multiple users having their own separate sessions on the large screen of the smart table.

In one embodiment, the invention provides for screen partitioning when the device is switched to multi-user mode. In this mode, each user can choose his/her side or portion of the screen, login via his/her specific login pattern and use it as a personal screen for email, web browsing, etc. Also, in one or more embodiments, while in multi-user session, the device may be configured to use user recognition techniques such as for example a smart voice recognition algorithm to process user commands and issue the action on the screen that is reserved for his/her session. Furthermore, the present system allows for peripheral accessories configured to provides for further interaction with the multi-user session, these peripherals may comprise for example a finger-print mouse or touch pad, a video conferencing camera, etc., that are capable to pair with the correct user specific session within the large screen.

In one or more embodiments, the smart table is configured to allow users to reserve a part of the screen for their own private session. Once in multi-user session mode, the device will allow individual users to start their private session on their choice of the screen space via their login pattern. Once logged in, that section of the screen will be customized to the active user's profile/preferences.

In one or more embodiments, the smart table may further comprise logic for input source recognition such as fingerprint detection, voice recognition and/or face recognition, and association of inputs from the user with the correct user/screen session may be implemented in the smart table. For example, in one or more embodiments, upon establishing the user specific session, the source/user associated with commands, e.g. voice or other user identifiable commands, received at the table will be identified as belonging to an “active” user. Upon making such determination, according to several embodiments, the action corresponding to the command may be implemented at the user specific session on the specific portion of the screen associated with the identified user. Different input means such as touch pads, touch screens, mouse, keyboard, camera, microphones, etc., having the capability for source recognition can be used to direct user actions to the specific user session being displayed on a specific portion of the screen. For example, when a user enters inputs via a touch pad, touch screen, mouse and/or keyboard having source recognition capability, e.g. fingerprint recognition, the smart table determines that the source of the input is associated with a specific user session and directs the action corresponding to the input/command to the appropriate section/window on the screen belonging to the identified input source/user. Similarly through source recognition, inputs received from a user monitored through a wireless video camera can be paired with the appropriate user session via face recognition.

In one embodiment, the present system allows the user to easily switch from a full screen mode, where all users only interact with the multi-user session, to a multi-user mode, where the user has a specific personalized session in addition to in lieu of the general multi-user session, by entering a request and/or a gesture. In one embodiment, for example the gesture may comprise a line or other pattern being entered at the smart table. For example, in one embodiment, a user may create a user specific session by drawing a line in the corner of the screen of the smart table. In another embodiment, the gesture may be entered through other inputs such a microphone or camera. In one embodiment, the gesture comprises a pre-assigned user specific gesture specially associated with the user. In one embodiment, where the source of the gesture is identifiable by the system, the gesture may act as both a request to start the session and may further act as login information for authentication and identification of the user. In other embodiments, if the gesture is not recognizable as user specific, upon entering the gesture the user may be asked to enter login information. Once within the user specific session the user may further be able to expand his screen or quit his session, and go back to full screen mode.

In one embodiment, for example, the user may terminate the session by entering a request and/or gesture. In one embodiment, the gesture may comprise crossing the session, closing the session, and or some other gesture or input, such as a voice command, a pattern, etc.

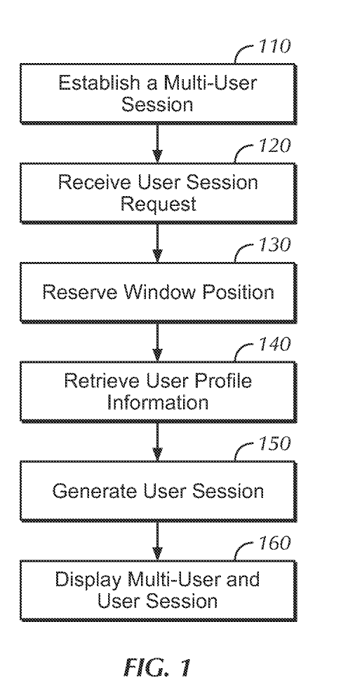

Referring to FIG. 1, a flow diagram of a method for establishing a multi-user session at the smart table is illustrated according to several embodiments of the present invention.

The process begins in step 110 by establishing a multi-user session having a plurality of users. In one embodiment, upon powering up the smart table device, or through a user input or other means the system may establish a multi-user session displayed at the table. At this time, the smart table is in full screen mode, i.e. all users are interacting with the same session. In one embodiment, the multi-user session is established according to a general profile. In one embodiment, the general profile comprises general and/or default account setting and preferences for the multi-user session. In one embodiment, the general profile comprises at least a desktop appearance specific to the multi-user session. The desktop appearance corresponds to items loaded onto the screen according to the profile information stored within the general profile. In one embodiment, the general profile comprises information similar to that of a setting for a user account at a regular Personal Computer (PC). The general information may comprise the tools and software available in the multi-user session, as well as window appearances, and other settings of the multi-user session. While in full screen mode, the users interacting with the table can provide inputs that are received and displayed generally to all users viewing the session. In one embodiment, the user inputs are performed at the location where the active applications running on the smart table in full screen mode reside. In one embodiment, upon establishing the multi-user session, the smart table system initiates a thread, where actions and processes associated with the multi-user session are carried out.

Next, in step 120, the system receives a session request from a first user of the plurality of users interacting with the multi-user session. In one embodiment, the user request comprises a gesture or action recognized by the system as a request for starting a private user specific session. In one embodiment, for example the gesture may comprise a line or other pattern being entered at the smart table. For example, in one embodiment, a user may create a user specific session by drawing a line in the corner of the screen of the smart table. In another embodiment, the gesture may be entered through other inputs such a microphone or camera.

Next, in step 130 the system detects and/or reserves a window position for the session request. In one embodiment, as described above, the user when requesting to start a user-specific session may draw a line or other pattern on the screen to start the session. In such embodiments, the area outlined by the user or some area corresponding to the outlined portion is designated as the window position for the user specific session and reserved for the specific user session. In another embodiment, where a different gesture or action is inputted by the user as the request to establish or initiate the user specific session, then the user may be queried for a desired window position or the system may assign a window position to the user.

For example, in one embodiment, the system may be configured to determine a position of the specific user, for example, based on a sensor input, such as an image sensor, voice sensor, position sensor, etc. In such embodiments, the system may reserve a window position for the user on the large screen based on the position determination. For example, if the user is detected as being at a right side of the able, then the window may be reserved at this side of the screen, such that the user is able to successfully access the window. In another embodiment, the window may be assigned to/reserved at a random position within the screen. Once the window has been reserved, the user may then view the window on the screen. In several embodiments, once the user is provided with a reserved window position, the user may be able to change the position of the window to a desirable position within the screen.

Next, the process moves to step 140 and retrieves a user profile for the specific user requesting to start the session. In some embodiments, as described above, the gesture may comprise a pre-assigned user specific gesture specially associated with the user. In such embodiments the gesture may act as both a request to start the session and may further act as login information for identification and/or authentication of the user. Accordingly, in such embodiments, upon detecting that the gesture is a user specific gesture, the system is capable of identifying the user and may retrieve the user profile information according to the identification.

In other embodiments, if the gesture is not recognizable as user specific or is a general gesture for all users, in step 120, upon entering the gesture the user may be asked to enter login information. In one embodiment, the user is provided with a login request to enter login information within the designated window reserved for the specific user session. In one embodiment, additional information may be requested for authenticating the user. For example, in one or more embodiments, inputs such as voice, fingerprint, touch, image, and/or other inputs may be entered by the user to authenticate the user. In another embodiment, the authentication may comprise a password. In yet another embodiment, a combination of such authentication techniques may be used for authenticating the user.

Upon identifying and/or authenticating the user, the system then accesses the identified user's profile. In one embodiment, the user profile comprises personalized account setting and preferences for the user specific session. In one embodiment, the user profile comprises at least a desktop appearance specific to the user specific session. The desktop appearance corresponds to items loaded onto the screen according to the profile information stored within the user profile. In one embodiment, the user profile comprises information similar to that of a setting for a user account at a regular Personal Computer (PC). The user information may comprise the tools and software available in the user specific session, as well as window appearances, and other settings of the user specific session.

Next, in step 150 the system generates a user session for the first user at the designated/reserved window position based on the user profile. Thus, in some embodiments, the user specific session is loaded according to the user profile retrieved in step 140. In one embodiment, establishing the user specific session comprises initiating a second thread running simultaneously with the multi-user session thread.

Finally, in step 160, the generated user specific session is displayed to the user at the designated window position. In some embodiments, the rest of the screen will be displaying the multi-user session and users are capable of interacting with the multi-user session. In one embodiment, once in multi-user session one or more windows are generated for each user requesting to create a session and displayed to the specific user. In several embodiments, in multi-user mode, the users interacting with the table can provide inputs that are received and executed within the specific window of the user specific session. For example, in one or more embodiments, upon establishing the user specific session, the source/user associated with commands, e.g. voice or other user identifiable commands, received at the table will be identified as belonging to an “active” user. Upon making such determination, according to several embodiments, the action corresponding to the command is implemented within the user specific session displayed within the designated window. In one embodiment, the user of the user specific session may be able to then share the data or active applications running at the user specific session with users of the multi-user session by dragging the application or data outside to the portion of the screen displaying the multi-user session. In an additional or alternative embodiment, the user of the user specific session may be able to share data or active applications running at the user specific session with a second user having a second user specific session by dragging the application or data outside to the portion of the screen displaying the second user specific session.

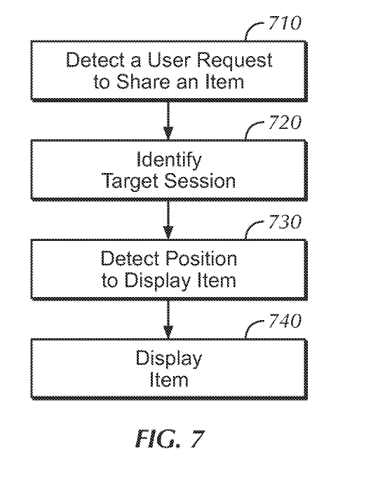

FIG. 7 illustrates a flow diagram of a process for sharing an item displayed at the user-specific session with one or more users at other sessions being displayed on the smart table.

The process begins in step 710 when the system detects a user request to share an Item. In one embodiment, the detection occurs when the user of the user specific session requests to share an item displayed within the user's user specific session at a second target session. In one embodiment, the item may comprise data or an application running at the user specific session. In one embodiment the request comprises the user of the user specific session performing a certain input gesture or pattern. For example, in one embodiment, the user may drag the item to a position outside the window where the user wishes the item to be displayed. In another embodiment, the user may select the item and a share menu may be displayed with a list of all sessions running at the smart table. In such embodiments, the user may select the target session from the listed active sessions. In one embodiment, the target session may comprise the multi-user session and/or other user-specific sessions being displayed at the smart table.

Upon detecting the request, in step 720, the system determines the target session that the user wishes to share the item with. In one embodiment, the determination may comprise determining the user session selected by the user, or may comprise determining the user session running at the specific location the user has dragged the item to.

Next, in step 730 the system determines a position for displaying the item. In one embodiment, for example, the system may determine that the target session is a user specific session of a second user. In such embodiments, the system in step 730 detects the window position of the user specific session of the second user and detects a position within the window position of the user specific session of the second user as the position for displaying the item. In another embodiment, the target session may comprise the multi-user session being displayed at the smart table. In such embodiments, the position for displaying the item may comprise any portion of the smart table display that is displaying the multi-user session, which in some embodiments may comprise any portion not displaying a user specific session.

Finally, in step 740 the item is displayed on the smart table display at the position determined in step 730.

In this and other embodiments, the smart table may comprise logic for input source recognition such as fingerprint detection, voice recognition and/or face recognition, so that user inputs from the user can be associated with the appropriate user-specific session. Different input means such as touch pads, touch screens, mouse, keyboard, camera, microphones, etc., having the capability for source recognition can be used to direct user actions to the specific user session being displayed on a specific window within the screen. For example, when a user enters inputs via a touch pad, touch screen, mouse and/or keyboard having source recognition capability, e.g., fingerprint recognition. The device may communicate with the smart table and automatically pair with the correct section of the screen belonging to the identified input source/user. Similarly through source recognition, inputs received from a user monitored through a wireless video camera can be paired with the appropriate user session via face recognition.

Once within the user specific session the user may further be able to change the characteristics of the window, expand his screen or quit his session, and go back to full screen mode.

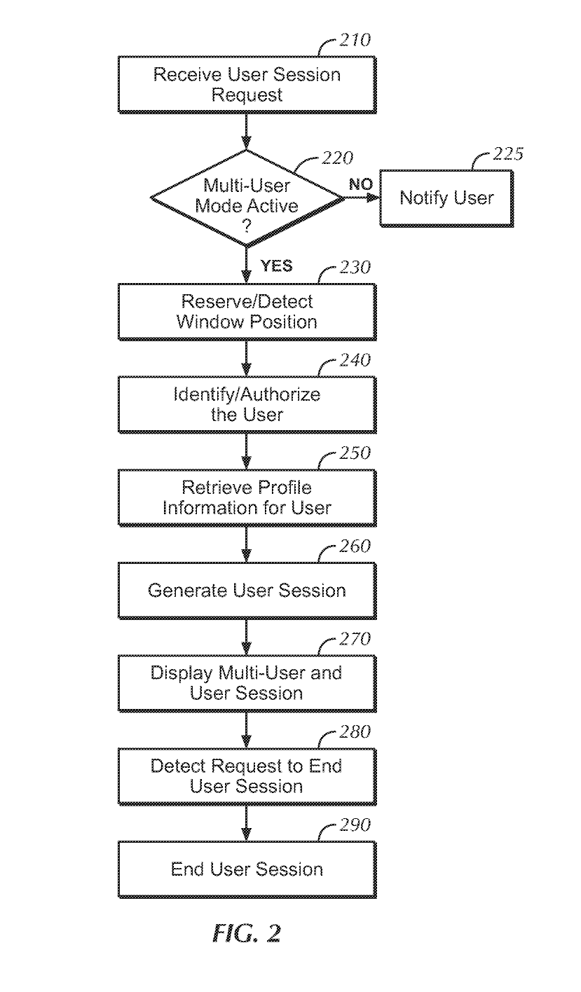

Next referring to FIG. 2, a more detailed flow diagram of a process for establishing a user session at the smart table is illustrated, according to several embodiments of the present invention.

The process begins in step 210 where the system detects/receives a private session request from a first user of the plurality of users, e.g., users interacting with a multi-user session. That is, according to one or more embodiments, the table may initially be in full screen mode and running a multi-user session. The user may enter a gesture or some equivalent input detected as an indication that the user wishes to begin a private session. In one embodiment, the gesture may comprise a line or other pattern being entered at the smart table. For example, in one embodiment, a user may create a user specific session by drawing a line in the corner of the screen of the smart table. In another embodiment, the gesture may be entered through other inputs such a microphone or camera.

Upon detecting the request, in step 220 the system first determines whether the system is in multi-user mode or whether multi-user mode is active. That is, the system first checks to see whether the option of creating private sessions are available at the table where the request is entered. In one embodiment, for example, the multi-user session may be activated by a system or table administrator or some other one of the users having the right access rights to activate the multi-user mode. In another embodiment, the multi-user mode may only be activated at specific times of the day.

In yet another embodiment, other requirements may determine whether the multi-user mode is activated. In one embodiment, further, the multi-user mode may only be available to certain users, and when determining if the mode is active the user may have to enter a password or other indication showing that the user is authorized to start a user specific session.

If in step 220 it is determined that the multi-user mode is not active, then the process continues to step 225 and the user is provided with a notification that the multi-user mode is not active and therefore the user does not have the option to create a private session. In one embodiment, upon receiving the notification the user may be able to activate the multi-user mode, or may issue a request to the system or a specific user to have the multi-user mode activated. In such embodiments, if the multi-user mode is activated then the system may continue to step 230.

When it is determined in step 220 that the multi-user mode is activated, then in step 230 the system detects and/or reserves a window position for the session request. In one embodiment, as described above, the user when requesting to start a user-specific session may draw a line or other pattern on the screen to start the session. In such embodiments, the area outlined by the user or some area corresponding to the outlined portion is designated as the window position for the user specific session and reserved for the specific user session. In another embodiment, where a different gesture or action is inputted by the user as the request to establish or initiate the user specific session, then the user may be queried for a desired window position or the system may assign a window position to the user.

For example, in one embodiment, the system may be configured to determine a position of the specific user, for example, based on a sensor input, such as an image sensor, voice sensor, position sensor, etc. In such embodiments, the system may reserve a window position for the user on the large screen based on the position determination. For example, if the user is detected as being at a right side of the table, then the window may be reserved at this side of the screen, such that the user is able to successfully access the window. In another embodiment, the window may be assigned to/reserved at a random position within the screen. Once the window has been reserved, the user may then view the window on the screen. In several embodiments, once the user is provided with a reserved window position, the user may be able to change the position of the window to a desirable position within the screen.

Next, in step 240, the system identifies and/or authenticates the user requesting to initiate the private session. In one embodiment, the authentication mechanism may be implemented locally at the smart table. Alternatively, in another embodiment, the authentication mechanism may be a network based authentication mechanism implemented through accessing an authentication system in communication with the smart table over a network, e.g. over the Internet. In some embodiments, as described above, when initiating the session the user may enter a gesture comprising a pre-assigned user specific gesture specially associated with the user. In such embodiments the gesture may act as both a request to start the session and may further act as login information for identification and/or authentication of the user. Accordingly, in such embodiments, upon detecting that the gesture is a user specific gesture, the system is capable of identifying or authenticating the user based on the entered gesture or request. As one example, in one embodiment, the gesture may comprise a voice command to begin a session. In one embodiment, the actual phrase to begin the session and/or the voice the phrase is spoken in may be used to identify and/or authenticated the user.

In other embodiments, if the gesture is not recognizable as user specific or is a general gesture for all users, in step 240, the user may be asked to enter login information. In one embodiment, the user is provided with a login request to enter login information within the designated window reserved for the specific user session. In one embodiment, additional information may be requested for authenticating the user. For example, in one or more embodiments, inputs such as voice, fingerprint, touch, image, or other inputs may be entered by the user and used by the system to authenticate the user. In another embodiment, the authentication may comprise a password. In yet another embodiment, a combination of such authentication techniques may be used for authenticating the user.

Upon identifying and/or authenticating the user, in step 250, the system retrieves a user profile for the specific user requesting to start the session. In one embodiment, the user profile may be stored locally at the smart table. In another embodiment, the user profile may be stored remotely at a database communicatively coupled to the smart table, for example over a wired or wireless network connection, e.g. LAN, WAN, etc. In one or more embodiments, the same user profile stored at a database, either at a smart table or at a remote database, may be accessible by different smart tables such that the user profile is not restricted to one device. Furthermore, in some embodiments, the user profile may be stored at a remote database as a backup mechanism.

In one embodiment, the general profile comprises general and/or default account setting and preferences for the user specific session. In one embodiment, the general profile comprises at least a desktop appearance specific to the user-specific session. The desktop appearance corresponds to items loaded onto the screen according to the profile information stored within the general profile. In one embodiment, the general profile comprises information similar to that of a setting for a user account at a regular Personal Computer (PC). The general information may comprise the tools and software available in the user specific session, as well as window appearances, and other settings of the user specific session.

Next, in step 260 the system generates a user session for the first user at the designated/reserved window position based on the user profile. Thus, in some embodiments, the user specific session is loaded according to the user profile retrieved in step 250. In one embodiment, establishing the user specific session comprises initiating a second thread running simultaneously with the multi-user session thread.

Finally, in step 270, the generated user specific session is displayed to the user at the designated window position. In some embodiments, the rest of the screen will be displaying the multi-user session and users are capable of interacting with the multi-user session. In one embodiment, once in multi-user mode one or more windows are generated for each user requesting to create a session and displayed to the specific user. In several embodiments, in multi-user mode, the users interacting with the table can provide inputs that are received and executed within the specific window of the user specific session. For example, in one or more embodiments, upon establishing the user specific session, the source/user associated with commands, e.g. voice or other user identifiable commands, received at the table will be identified as belonging to an “active” user. Upon making such determination, according to several embodiments, the action corresponding to the command is implemented within the user specific session displayed within the designated window.

In this and other embodiments, the smart table may comprise logic for input source recognition such as fingerprint detection, voice recognition and/or face recognition, so that user inputs from the user can be associated with the appropriate user-specific session. Different input means such as touch pads, touch screens, mouse, keyboard, camera, microphones, etc., having the capability for source recognition can be used to direct user actions to the specific user session being displayed on a specific section of the screen. For example, when a user enters inputs via a touch pad, touch screen, mouse and/or keyboard having source recognition capability, e.g. fingerprint recognition, the device may communicate with the smart table and automatically pair with the correct section of the screen belonging to the identified input source. Similarly through source recognition, inputs received from a user monitored through a wireless video camera can be paired with the appropriate user session via face recognition.

Once within the user specific session the user may further be able to change the characteristics of the window, expand his screen or quit his session, and go back to full screen mode. In one embodiment, for example, the user may terminate the session by entering a request and/or gesture. In one embodiment, the gesture may comprise crossing the session, closing the session, and or some other gesture or input, such as a voice command, a pattern, etc.

In step 280, the system detects the request to terminate the user specific session and continues to step 290 and terminates the session. In one embodiment, in step 280, upon receiving the request for terminating the user specific session the system may generate a notification and display the notification to the user and the termination in step 290 is performed if the user confirms that the session should be terminated. In one embodiment, upon the session being terminated, the user of the specific session may interact with the multi-user session. In one embodiment, the reserved portion of the window which displayed the user specific session is removed and the portion may display the multi-use session. In one embodiment, further, upon termination any devices associated with the user specific session may be assigned to the multi-user session as default. In another embodiment, the user may be presented with a list prior to the termination of the session and the user may choose whether to disconnect the device, or to assign the device to another session, e.g. a second user specific session for a second user, a multi-user session, or a new user specific session for the user.

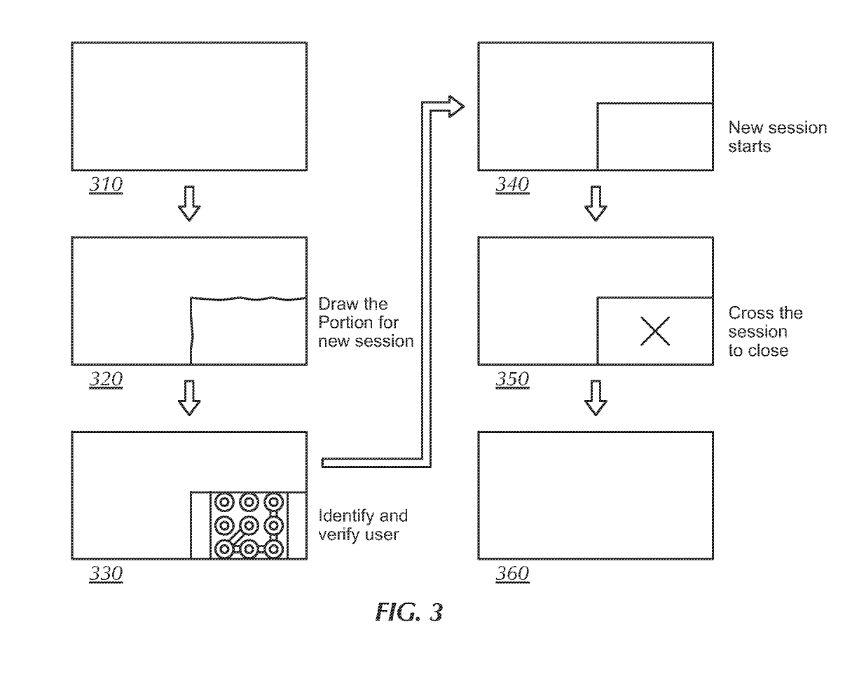

FIG. 3 illustrates exemplary screen shots of the table while the process of creating a user specific session is being performed. Screen shot 310 shows the screen of the smart table when the system is in full screen mode. Typically, in this stage a multi-user session may be in progress and one or more users are able to interact with the multi-user session.

Screen shot 320 shows the screen of the smart table when the user initiates the process of creating the user specific session according to the methods and techniques described with respect to embodiments of the present invention. In this exemplary embodiment, the user initiates the process by drawing a line at a corner of the smart table screen. As described above, other gestures may be used in other embodiments to begin the process.

Next, as shown in screen shot 330, the table depicts a window placed generally approximate to the lines drawn by the user and provides means for identifying, authenticating and/or verifying the user according to the embodiments described with respect to embodiments of the present invention.

As shown in the screen shot 340, once the user is identified, verified and/or authenticated, the user specific session begins and the user is able to interact with the user specific session as described throughout.

The user may then choose to terminate the user specific session. For example, as shown in screen shot 350, the user may cross the session to close the window and end the user specific session. Once the request to terminate the session is received, the system closes the session.

Next, as shown in screen shot 360, the table is again in full screen mode and the user is able to interact with the multi-user session in progress. While in this exemplary embodiment, only one user specific window is displayed, it should be understood by one of ordinary skill in the art, that each of a plurality of users of the smart table may initiate their own user specific session at a location within the screen of the smart table.

As described above, when the table enters multi-user mode, i.e. when the system is simultaneously running multiple sessions, i.e. at least a multi-user session and a first user specific session, inputs from the users may be received and the source of the input may be determined. In such embodiments, based on the source recognition, the system then determines whether the input should be executed at the multi-user session or within one of the one or more user specific sessions running at the smart table.

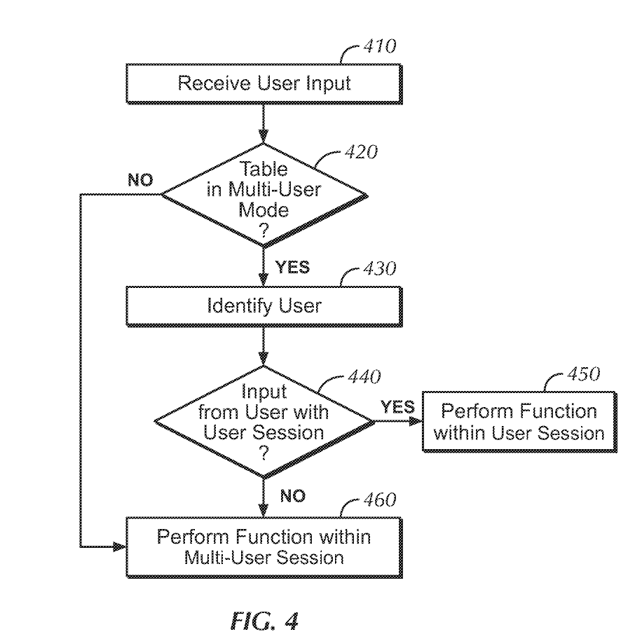

Referring to FIG. 4 a flow diagram of a process for receiving and executing user inputs/commands received at the smart table is illustrated according to one or more embodiments of the present invention.

In step 410 a user input is received at the smart table. In one embodiment, the input is received through one of a plurality of input means available at the smart table. Such input means or devices may comprise buttons, touch pads, microphones, fingerprint pad, touch screen, a mouse, keyboard, camera, microphones, game controller, joystick, or other types of user input devices. In one embodiment, one or more of the input means may be integrated with or fixably attached to the smart table. In another embodiment, one or more of the input means may comprise one or more peripheral devices coupled to the smart table through wired or wireless means.

Upon detecting a user input, the system continues to step 420 and determines whether the smart table is in multi-user mode. As described above, the smart table may operate in one of a full screen mode, i.e. where a multi-user session is solely running at the table and all users are interacting with the single multi-user session, and a multi-user mode, where one or more users have initiated a user specific session.

If, in step 420, it is determined that the smart table is not in multi-user mode, i.e., that the only active session at the table is a multi-user session, then the process continues to step 460. In step 460 the system implements the function corresponding to the input within the multi-user session running on the smart table.

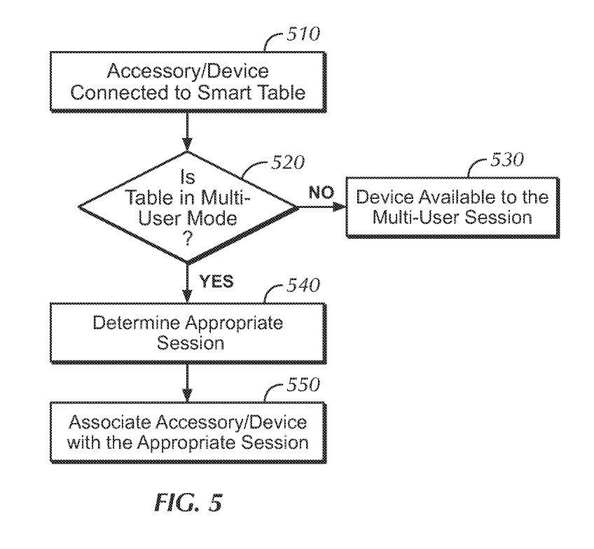

Otherwise, when in step 420 it is determined that the smart table is running more than one session, including one or more user specific sessions, the process continues to step 430. In step 430, the system processes the input to identify the source of the input, i.e., user. In one or more embodiments, the smart table comprises logic for input source recognition such as fingerprint detection, voice recognition and/or face recognition. In such embodiments, the system is able to determine the source/user associated with commands, e.g. voice or other user identifiable commands, received at the table. In some embodiments, input means may be assigned to a specific user for example upon being coupled to the smart table. For example, a touch pad, touch screen, mouse and/or keyboard can talk to the smart table and automatically pair with the correct user and/or user specific session. The process of coupling an input device to the smart table is described in further detail below with respect to FIG. 5.

Upon making such determination, according to several embodiments, the process then continues to step 440 and determines whether the user associated with the input received has an active user specific session running. That is, in one embodiment, during this step, the system upon determining the identity of the source of the input compares the identified user against the one or more users having a user specific session. In another embodiment, during step 440 the system may additionally or alternatively determine if the input device is associated with a specific session.

If it is determined in step 440, that the user identified in step 430 is associated with an active user specific session running at the smart table, and/or that the input device is associated with a specific session, in step 450, the action corresponding to the command/user input may be implemented at user specific session on the specific portion of the screen/window associated with the identified user or user specific session. Different input means such as touch pads, touch screens, mouse, keyboard, camera, microphones, etc. having the capability for source recognition can be used to direct user actions to the specific user session being displayed on a specific section of the screen. For example, when a user enters inputs via a touch pad, touch screen, mouse and/or keyboard having source recognition capability, e.g. fingerprint recognition, the smart table determines that the source of the input is associated with a specific user session and directs the action corresponding to the input/command to the appropriate section/window on the screen belonging to the identified input source/user. Similarly through source recognition, inputs received from a user monitored through a wireless video camera can be paired with the appropriate user session via face recognition.

Alternatively, if in step 440, it is determined that the input is from a user that is not associated with the user specific session, the process then continues to step 460. In step 460 the system implements the function corresponding to the input within the multi-user session running on the smart table.

FIG. 5 illustrates a flow diagram of a method for coupling an input device to the smart table. Such input means or devices may comprise input means integrated with the smart table, e.g. buttons, touch pads, microphones, fingerprint pad, touch screen, a mouse, keyboard, camera, game controller, joystick, or other types of peripheral input devices. In one embodiment, one or more of the input means may be integrated with or fixably attached to the smart table. In another embodiment, one or more of the input means may comprise one or more peripheral devices coupled to the smart table through wired or wireless means.

The process begins in step 510 when a device is coupled to/or initiated at the smart table. In one embodiment, as described above, the device may be connected by wireless or wired means such as through a cord, USB, Bluetooth, wireless communication etc.

Upon detecting the device, in step 520 the system determines whether the table is in multi-user mode. As described above, the smart table may operate in one of a full screen mode, i.e. where a multi-user session is solely running at the table and all users are interacting with the single multi-user session, and a multi-user mode, where one or more users have initiated a user specific session.

If in step 520 the system determines that the table is in multi-user mode, then in step 530 the device is made available to/assigned to the multi-user session. In some embodiments, this means that the inputs from the device are executed within the multi-user session running on the device.

Otherwise, if it is determined in step 520 that the table is not in multi-user mode, in step 540 the system may query the one or more users at the session, and/or the specific user coupling the device to the table for the user session that the device should be assigned to. In one embodiment, for example, the user/users are provided with a list of all active sessions running at the smart table. The user or user is then able to select one user specific session to assign to the device. In another embodiment, the list may further comprise the multi-user session running simultaneously with the user specific sessions and the user can select to assign the user to the multi-user session such that all inputs from the device are carried out at the multi-user session. In one embodiment, the system may require that the selection of the appropriate session is received from the coupled device to make sure that the authorized user is making the selection.

Next, in step 550, the device is associated with the appropriate session based on the selection made by the user. In such embodiments, after the device is assigned to the user session, any inputs by the device will be carried out within the specific session associated with the device. In another embodiment, the device may be linked with that session as long as the session is running. If the session is terminated at any time, then the table may assign the device to the multi-user session or may alternatively query the user for the session that the device should be assigned to for example similar to step 540 and may assign the device to the appropriate session. In another embodiment, at any time, the user may switch the session to which the device is assigned to by providing an input at the table.

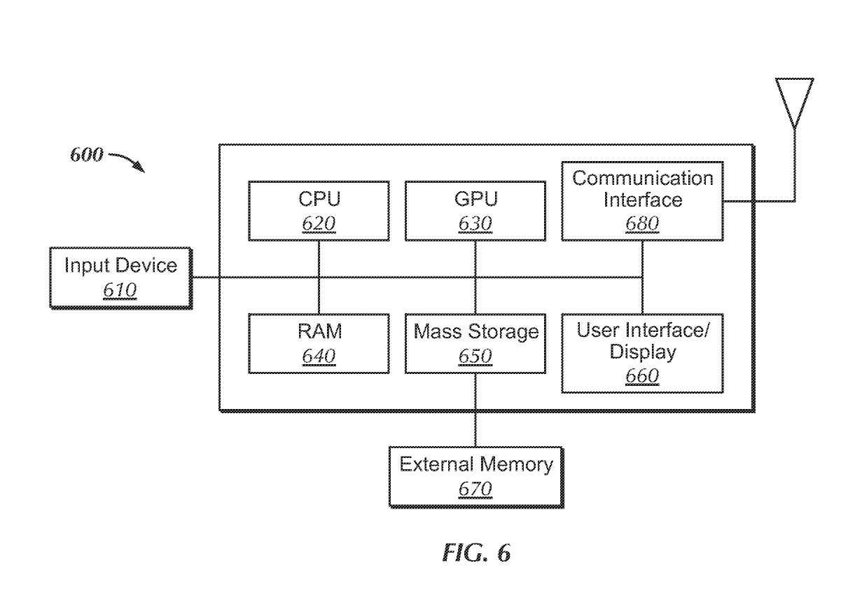

The methods and techniques described herein may be utilized, implemented and/or run on many different types of systems. Referring to FIG. 6, there is illustrated a system 600 that may be used for any such implementations. One or more components of the system 600 may be used for implementing any system or device mentioned above, such as for example any of the above-mentioned smart table, display devices, computing devices, applications, modules, databases, input devices, etc. However, the use of the system 600 or any portion thereof is certainly not required.

By way of example, the system 600 may comprise a Central Processing Unit a User Input Device 610, (CPU) 620, a Graphic Processing Unit (GPU) 630, a Random Access Memory (RAM) 640, a mass storage 650, such as a disk drive, a user interface 660 such as a display, External Memory 670, and Communication Interface 680. The CPU 620 and/or GPU 630 may be used to execute or assist in executing the steps of the methods and techniques described herein, and various program content, images, games, simulations, representations, interfaces, sessions, etc., may be rendered on the user interface 660. The system 600 may further comprise a user input device 610. The user input device may comprise any user input device such a keyboard, mouse, touch pad, game controller, etc.

Furthermore, the system 600 may comprise a communication interface 680 such as a communication port for establishing a communication with one or more other processor-based systems and receiving one or more content. In one embodiment, the communication interface 680 may further comprise a transmitter for transmitting content, messages, or other types of data to one or more systems such as external devices, applications and/or servers. The system 600 comprises an example of a processor-based system.

The mass storage unit 650 may include or comprise any type of computer readable storage or recording medium or media. The computer readable storage or recording medium or media may be fixed in the mass storage unit 650, or the mass storage unit 650 may optionally include external memory and/or removable storage media 670, such as a digital video disk (DVD), Blu-ray disc, compact disk (CD), USB storage device, floppy disk, or other media. By way of example, the mass storage unit 650 may comprise a disk drive, a hard disk drive, flash memory device, USB storage device, Blu-ray disc drive, DVD drive, CD drive, floppy disk drive, etc. The mass storage unit 650 or external memory/removable storage media 670 may be used for storing code that implements the methods and techniques described herein.

Thus, external memory and/or removable storage media 670 may optionally be used with the mass storage unit 650, which may be used for storing code that implements the methods and techniques described herein, such as code for generating and storing the tag data described above, performing the initiation of a session, evaluating, and matching of the users. However, any of the storage devices, such as the RAM 640 or mass storage unit 650, may be used for storing such code. For example, any of such storage devices may serve as a tangible computer storage medium for embodying a computer program for causing a console, system, computer, or other processor based system to execute or perform the steps of any of the methods, code, and/or techniques described herein. Furthermore, any of the storage devices, such as the RAM 640, mass storage unit 650 and/or external memory 670, may be used for storing any needed database(s), tables, content, etc.

In some embodiments, one or more of the embodiments, methods, approaches, and/or techniques described above may be implemented in a computer program executable by a processor-based system. By way of example, such processor based system may comprise the processor based system 600, or a television, mobile device, tablet computing device, computer, entertainment system, game console, graphics workstation, etc. Such computer program may be used for executing various steps and/or features of the above-described methods and/or techniques. That is, the computer program may be adapted to cause or configure a processor-based system to execute and achieve the functions described above.

For example, such computer program may be used for implementing any embodiment of the above-described steps or techniques for generating tag data and matching players based on the tag data, etc. As another example, such computer program may be used for implementing any type of tool or similar utility that uses any one or more of the above described embodiments, methods, approaches, and/or techniques. In some embodiments, program code modules, loops, subroutines, etc., within the computer program may be used for executing various steps and/or features of the above-described methods and/or techniques. In some embodiments, the computer program may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein.

For example, in some embodiments the present invention provides a computer-readable storage medium storing a computer program for use with a computer simulation, the computer program adapted to cause a processor based system to execute steps comprising establishing a multi-user session having a plurality of users according to a general profile, the general profile comprising at least a desktop appearance specific to the multi-user session, receiving a session request from a first user of the plurality of users, retrieving a user profile for the first user, detecting a window position for the session request and generating a user session for the first user at the window position based on the user profile, the user profile comprising at least a desktop appearance specific to the first user, wherein the user session runs simultaneously with the multi-user session and simultaneously displaying the multi-user session including a desktop corresponding to the desktop appearance specific to the multi-user session and the user session including a desktop corresponding to the desktop appearance specific to the first user, the user session being displayed at a location corresponding to the detected window position.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A device comprising:
a processor configured to perform steps comprising:
establishing a multi-user session having a plurality of users according to a general profile, the general profile comprising at least a desktop appearance specific to the multi-user session;
receiving a session request from a first user of the plurality of users;
retrieving a user profile for the first user;
detecting a window position for the session request; and
generating a first user session for the first user at the window position based on the user profile, the user profile comprising at least a desktop appearance specific to the first user;
wherein the first user session runs simultaneously with the multi-user session; and
a display for simultaneously displaying the multi-user session including a desktop corresponding to the desktop appearance specific to the multi-user session and the first user session including a desktop corresponding to the desktop appearance specific to the first user, the first user session being displayed at a location corresponding to the detected window position.

2. The device of claim 1, wherein the processor is further configured to perform the steps of:
detecting an input;
determining whether the input is from the first user; and
performing a function corresponding to the input in the first user session if it is determined that the input is from the first user.

3. The device of claim 2, wherein the processor is further configured to perform the steps of:
determining that the input is from another one of the plurality of users;
determining whether the another one of the plurality of users is assigned to a second user session; and
performing the function corresponding to the input in the second user session if it is determined that the another one of the plurality of users is assigned to the second user session.

4. The device of claim 3, wherein the processor is further configured to perform the steps of:
performing the function corresponding to the input in the multi-user session if it is determined that the another one of the plurality of users is not assigned to the second user session.

5. The device of claim 2, wherein the input is received through an input means and wherein the processor is further configured to determine a source of the input to determine whether the input is from the first user.

6. The device of claim 5, wherein the input means comprises a microphone and the input comprises a voice command and wherein determining the source of the input comprises determining a speaker of the input by voice recognition.

7. The device of claim 5, wherein the input means comprises a finger print detection device and wherein determining the source of the input comprises detecting a fingerprint and determining whether the fingerprint belongs to the first user.

8. The device of claim 2, wherein the steps further comprise:
receiving input from a camera comprising a first image;
wherein determining whether the input is from the first user comprises determining whether the first image corresponds to an image associated with the first user.

9. The device of claim 1, wherein the receiving the session request from the first user comprises receiving login information from the first user.

10. The device of claim 1, wherein the steps further comprise:
detecting a request from the first user to share an item displayed at the first user session with a target session displayed at the display;
detecting a position for displaying the item; and
displaying the item at the position.

11. The device of claim 10, wherein the target session comprises the multi-user session.

12. The device of claim 10, wherein the target session comprises a second user session displayed at the display simultaneously with the first user session and the multi-user session.

13. A method comprising:
establishing a multi-user session having a plurality of users according to a general profile, the general profile comprising at least a desktop appearance specific to the multi-user session;
receiving a session request from a first user of the plurality of users;
retrieving a user profile for the first user;
detecting a window position for the session request;
generating a first user session for the first user at the window position based on the user profile, the user profile comprising at least a desktop appearance specific to the first user, wherein the first user session runs simultaneously with the multi-user session; and
simultaneously displaying the multi-user session including a desktop corresponding to the desktop appearance specific to the multi-user session and the first user session including a desktop corresponding to the desktop appearance specific to the first user, the first user session being displayed at a location corresponding to the detected window position.

14. The method of claim 13, further comprising:
detecting an input;
determining whether the input is from the first user; and
performing a function corresponding to the input in the first user session if it is determined that the input is from the first user.

15. The method of claim 14, further comprising:
determining that the input is from another one of the plurality of users;
determining whether the another one of the plurality of users is assigned to a second user session; and
performing the function corresponding to the input in the second user session if it is determined that the another one of the plurality of users is assigned to the second user session.

16. The method of claim 15, further comprising:
performing the function corresponding to the input in the multi-user session if it is determined that the another one of the plurality of users is not assigned to the second user session.

17. The method of claim 15, wherein the input is received through an input means and wherein determining whether the input is from the first user comprises determining a source of the input.

18. The method of claim 17, wherein the input means comprises a microphone and the input comprises a voice command and wherein determining the source of the input comprises determining a speaker of the voice command by voice recognition.

19. The method of claim 17, wherein the input means comprises a finger print detection device and wherein determining the source of the input comprises detecting a fingerprint and determining whether the fingerprint belongs to the first user.

20. The method of claim 13, further comprising:
receiving an input from a camera comprising a first image;
wherein determining whether the input is from the first user comprises determining whether the first image corresponds to an image associated with the first user.

21. The method of claim 13, wherein the receiving the session request from the first user comprises receiving login information from the first user.

22. The method of claim 13, wherein generating the first user session for the first user comprises retrieving window information for the first user from the user profile and generating the first user session according to the window information for the first user.

23. The method of claim 13, further comprising:
detecting a request from the first user to share an item displayed at the first user session with a target session;
detecting a position for displaying the item; and
displaying the item at the position.

24. The method of claim 23, wherein the target session comprises the multi-user session.

25. The method of claim 23, wherein the target session comprises a second user session displayed simultaneously with the first user session and the multi-user session.

26. A tangible non-transitory computer readable medium storing one or more computer readable programs adapted to cause a processor based system to execute steps comprising:
establishing a multi-user session having a plurality of users according to a general profile, the general profile comprising at least a desktop appearance specific to the multi-user session;
receiving a session request from a first user of the plurality of users;
retrieving a user profile for the first user;
detecting a window position for the session request;
generating a first user session for the first user at the window position based on the user profile, the user profile comprising at least a desktop appearance specific to the first user wherein the first user session runs simultaneously with the multi-user session; and
simultaneously displaying the multi-user session including a desktop corresponding to the desktop appearance specific to the multi-user session and the first user session including a desktop corresponding to the desktop appearance specific to the first user, the first user session being displayed at a location corresponding to the detected window position.
